(19) United States
(12) Patent Application Publication
(10) Pub. No.: US 2015/0030282 A1
(43) Pub. Date: Jan. 29, 2015

(54) OPTICAL DEVICE AND MANUFACTURING METHOD THEREOF

(71) Applicant: Electronics and Telecommunications Research Institute, Daejeon (KR)

(72) Inventors: Hyundai PARK, Daejeon (KR); Jaegyu PARK, Daejeon (KR); JiHo JOO, Daejeon (KR); Gyungock KIM, Daejeon (KR)

(73) Assignee: Electronics and Telecommunications Research Institute, Daejeon (KR)

(21) Appl. No.: 14/157,426

(22) Filed: Jan. 16, 2014

(30) Foreign Application Priority Data
Jul. 25, 2013 (KR) 10-2013-0088124

(51) Int. Cl. G02B 6/12; G02B 6/13

(52) U.S. Cl. CPC G02B 6/12004; G02B 6/13
USPC 385/14; 438/31

(57) ABSTRACT

Provided is an optical device including a first optical waveguide on one side of a substrate; a laser separated from the first optical waveguide and disposed on the other side of the substrate; and a first coupled waveguide between the laser and the first optical waveguide. The laser may be monolithically integrated on the substrate.

### CROSS-REFERENCE TO RELATED APPLICATIONS

This U.S. non-provisional patent application claims priority under 35 U.S.C. §119 of Korean Patent Application No. 10-2013-0088124, filed on Jul. 25, 2013, the entire contents of which are hereby incorporated by reference.

### BACKGROUND OF THE INVENTION

The present invention disclosed herein relates to an optical device and a manufacturing method thereof, and more particularly, to a single mode distributed feedback laser.

A high-efficiency low-cost optical integrated circuit necessarily needs integration of a laser light source.

An indirect bandgap material, such as silicone or silica has been widely used as an optical integrated circuit. The indirect bandgap material has a limitation in that it may not be used as a light source because light emission efficiency of the material is low. Since a direct bandgap material has high light emission efficiency, it has been mainly used as a laser light source.

A laser light source chip of the direct bandgap material may be disposed on a silicon integrated circuit by using a flip chip bonding method. Generally, the flip chip bonding method needs an alignment error smaller than about 1 μm between the laser light source chip and a waveguide of the silicon integrated circuit. A flip chip bonding device has a limitation in that productivity is low because a significant alignment time is consumed to decrease the alignment error.

### SUMMARY OF THE INVENTION

The present invention provides an optical device an optical device and a manufacturing method thereof that may enhance productivity.

The present invention also provides an optical device and a manufacturing method thereof that may implement high optical efficiency.

Embodiments of the inventive concept provide optical devices include a first optical waveguide on one side of a substrate; a laser separated from the first optical waveguide and disposed on the other side of the substrate; and a first coupled waveguide between the laser and the first optical waveguide, wherein the laser is monolithically integrated on the substrate.

In some embodiments, the laser may have a ship shape.

In other embodiments, the ship-shaped laser may include a laser center waveguide having any line width; and a first laser edge waveguide and a second laser edge waveguide connected respectively to both sides of the laser center waveguide and tapered from the laser center waveguide.

In even other embodiments, the first optical waveguide may be tapered toward the laser.

In yet other embodiments, the laser may include a distributed feedback (DFB) laser.

In further embodiments, the laser may include a lower clad layer; an active layer on the lower clad layer; and an upper clad layer on the active layer, wherein the lower clad layer, the active layer and the upper clad layer comprise a III-V semiconductor.

In still further embodiments, the laser may further include a first electrode on the lower clad layer; and a second electrode on the upper clad layer.

In even further embodiments, the first coupled waveguide may cover the lower clad layer, the active layer, the upper clad layer, and the second electrode.

In yet further embodiments, the laser may further include first Bragg diffraction gratings disposed any one of the lower clad layer and the upper clad layer.

In even much further embodiments, the laser may generate a laser light having a wavelength proportional to a period of the first Bragg diffraction gratings as well as a width of the center laser waveguide.

In much further embodiments, the optical device may further include a second optical waveguide disposed on the other side of the laser facing the first optical waveguide; and a second coupled waveguide between the second optical waveguide and the laser.

In still much further embodiments, the optical device may further include second Bragg diffraction gratings disposed on at least any one of the first coupled waveguide and the second coupled waveguide.

In even much further embodiments, the laser may generate a laser light having a wavelength proportional to a period of the second Bragg diffraction gratings.

In yet much further embodiments, the optical device may further include third Bragg diffraction gratings disposed on at least any one of the first optical waveguide and the second optical waveguide.

In still yet much further embodiments, the optical device may further include a buffer layer between the laser and the substrate or between the optical waveguide and the substrate.

In other embodiments of the inventive concept, methods of manufacturing an optical device include forming an optical waveguide on one side of a first substrate; forming a laser on the other side of the first substrate spaced apart from the optical waveguide; and forming a coupled waveguide on the first substrate between the laser and the optical waveguide. The laser may be monolithically formed by using a wafer bonding technique.

In some embodiments, the wafer may include a second substrate; an upper clad layer on the second substrate; an active layer on the upper clad layer; and a lower clad layer on the active layer. The lower clad layer may be bonded to the other side of the first substrate.

In other embodiments, the forming of the laser may include pattering the upper clad layer, the active layer, and the lower clad layer in a ship shape.

In still other embodiments, the method may further include forming a buffer layer on the first substrate under the lower clad layer.

### BRIEF DESCRIPTION OF THE DRAWINGS

The accompanying drawings are included to provide a further understanding of the present invention, and are incorporated in and constitute a part of this specification. The drawings illustrate exemplary embodiments of the inventive concept and, together with the description, serve to explain principles of the present invention. In the drawings:

FIG. 1 is a schematic perspective view of an optical device according to an embodiment of the inventive concept;

FIG. 2 is a sectional view of a laser of FIG. 1;

FIGS. 3A to 3E illustrate the respective waveguide modes of a laser light in an optical device of the present invention;

FIG. 4 is a graph of tapered length changes of a first optical waveguide and a first laser edge waveguide of FIG. 1 vs. optical loss;

FIG. 5 is a perspective view of an optical device according to a second embodiment of the inventive concept;

FIG. 6 is a perspective view of an optical device according to a third embodiment of the inventive concept;

FIG. 7 is a perspective view of an optical device array according to a first application of the present invention;

FIG. 8 is a perspective view of an optical device array according to a second application of the present invention; and

FIGS. 9A to 9F are sequential sectional views of a method of manufacturing an optical device of the present invention.

### DETAILED DESCRIPTION OF PREFERRED EMBODIMENTS

Exemplary embodiments are described below in detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining specific embodiments while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. It will be understood that when an element such as a layer, film, region, or substrate is referred to as being “on” another element, it can be directly on the other element or intervening elements may also be present.

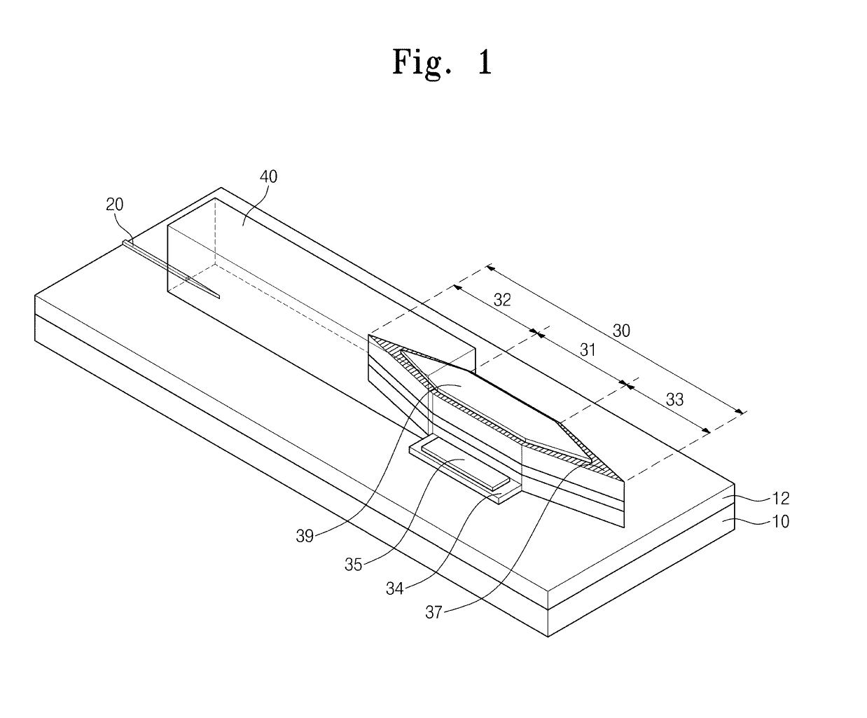

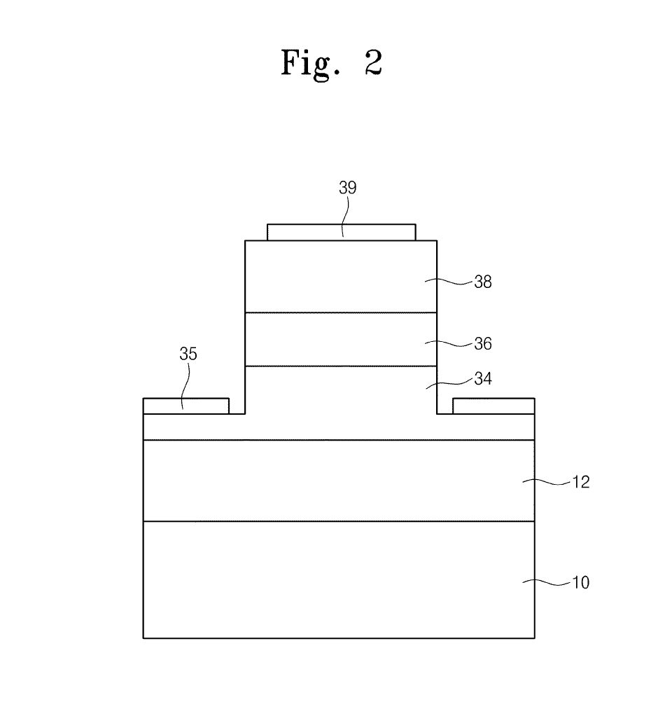

FIG. 1 is a schematic perspective view of an optical device according to an embodiment of the inventive concept. FIG. 2 is a sectional view of a laser 30 of FIG. 1.

Referring to FIGS. 1 and 2, the optical device of the present invention may include a first substrate 10, a buffer layer 12, a first optical waveguide 20, a laser 30, and a first coupled waveguide 40. The first substrate 10 may include crystalline silicon. The buffer layer 12 may be disposed on the first substrate 10. The buffer layer 12 may include a silicon dioxide film.

The first optical waveguide 20 may be disposed on one side of the first substrate 10. The first optical waveguide 20 may include a silicon optical waveguide. The first optical waveguide 20 may be tapered within the first coupled waveguide 40.

The first coupled waveguide 40 may be disposed on the first substrate 10 between the first optical waveguide 20 and the laser 30. The first coupled waveguide 40 may include a silicon oxide nitride (SiON) film.

The laser 30 may be disposed on the other side of the first coupled waveguide 40 facing the first optical waveguide 20 on the first substrate 10. The laser 30 may have a sip shape. The ship-shaped laser 30 may be divided into a laser center waveguide 31, a first laser edge waveguide 32, and a second laser edge waveguide 33. The first laser edge waveguide 32 and the second laser edge waveguide 33 may be tapered toward both sides of the laser center waveguide 31. The first optical waveguide 20 may be tapered toward the laser 30.

The laser 30 may include a III-V semiconductor layer that is monolithically integrated on the first substrate 10. The laser 30 may include a lower clad layer 34, an active layer 36, an upper clad layer 38, a first Bragg diffraction gratings 37, a first electrode 35, and a second electrode 39. The lower clad layer 34 may include the III-V semiconductor layer including InP, AlGaAs, and InGaP that is doped with a first conductive impurity. The upper clad layer 38 may include the III-V semiconductor layer including InP, AlGaAs, and InGaP that is doped with a second conductive impurity. The active layer 36 may include the III-V semiconductor layer including InGaAsP, InGaAlAs, AlGaAs, GaAs, and InGaAs of a multiple quantum well structure. The first electrode 35 is disposed on the lower clad layer 34. The second electrode 39 is disposed on the upper clad layer 38. The first Bragg diffraction gratings 37 may be disposed in the lower clad layer 34 or the upper clad layer 38.

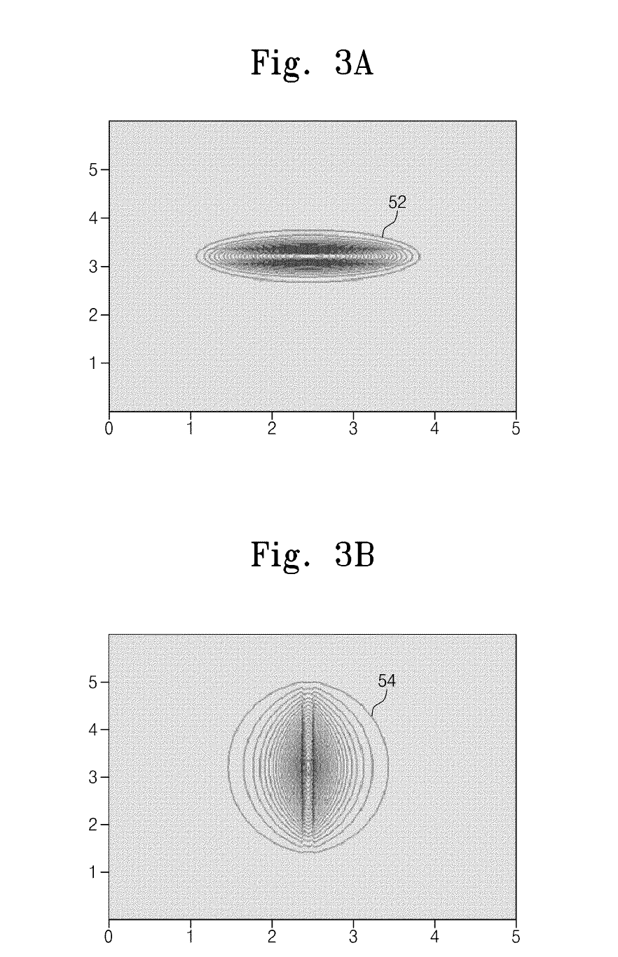

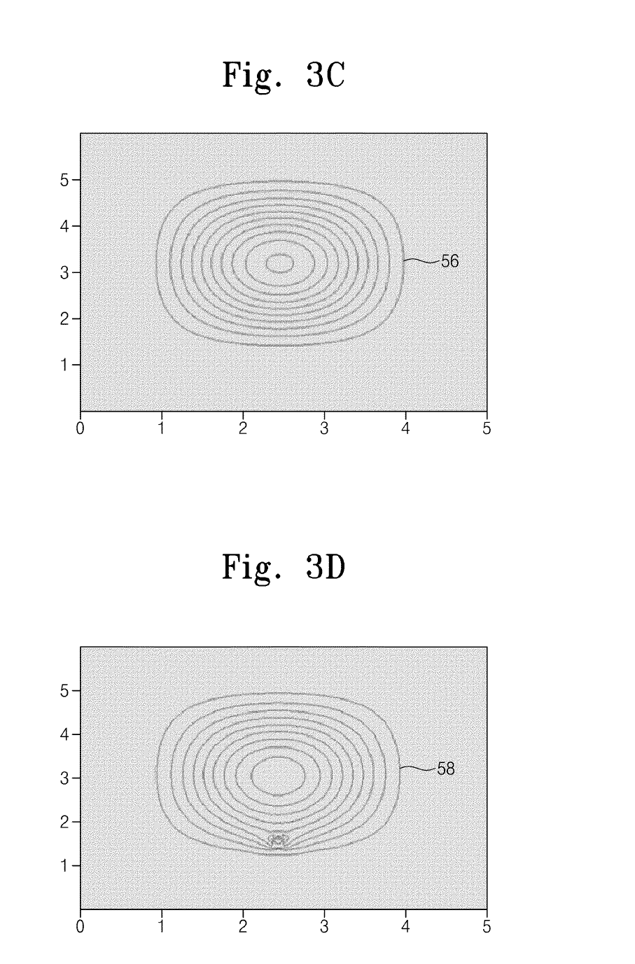

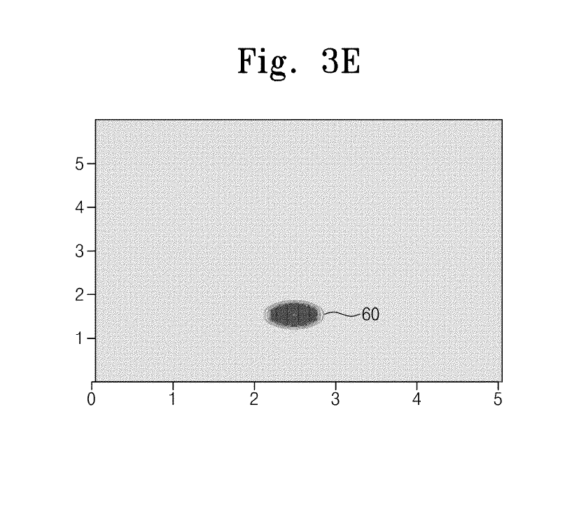

FIGS. 3A to 3E illustrate the respective waveguide modes of a laser light in an optical device of the present invention.

Referring to FIGS. 3A to 3E, a first waveguide mode 52 may be calculated in the laser center waveguide 31. The first waveguide mode 52 may have an ellipsis shape having a long axis parallel to a substrate. A second waveguide mode 54 may be calculated in the first laser edge waveguide 32 and the first coupled waveguide 40. The second waveguide mode 54 may have a circle shape. A third waveguide mode 56 may be calculated in the first coupled waveguide 40. A fourth waveguide mode 58 may be calculated in the first optical waveguide 20 and the first coupled waveguide 40. The third waveguide mode 56 and the fourth waveguide mode 58 may have a rectangle shape. A fifth waveguide mode 60 may be calculated in the first optical waveguide 20. The fifth waveguide mode 60 may have a dot shape.

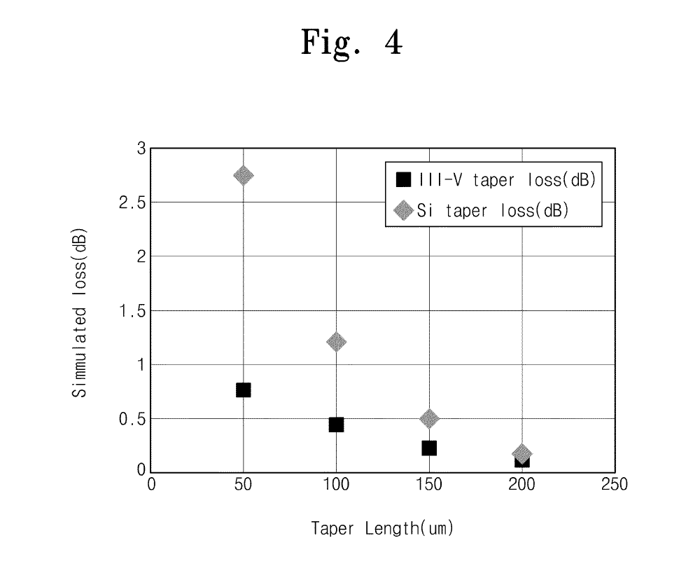

FIG. 4 is a graph of tapered length changes of a first optical waveguide 20 and a first laser edge waveguide 32 of FIG. 1 vs. optical loss.

Referring to FIG. 4, the first laser edge waveguide 32 and the first optical waveguide 20 may have an optical loss of about 0.5 dB or lower when having a tapered length of about 150 μm or longer. The first optical waveguide 20 and the laser 30 that are tapered over a certain length in the first coupled waveguide 40 may have minimized optical loss. The tapered first optical waveguide 20 and the tapered laser 30 can be aligned accurately through the photolithography process, not the mechanical alignment of flip-chip bonding process.

Thus, the optical device according to a first embodiment of the inventive concept may enhance productivity.

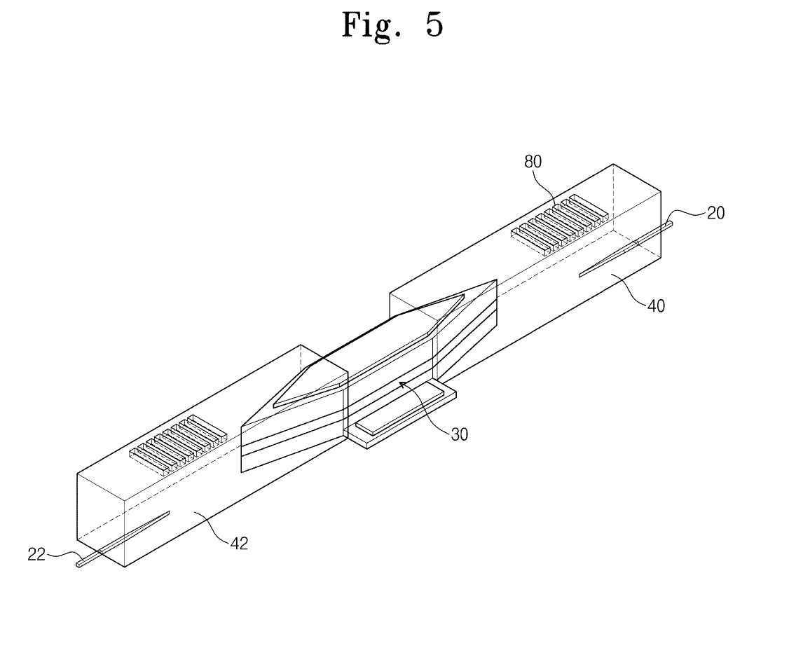

FIG. 5 is a perspective view of an optical device according to a second embodiment of the inventive concept.

Referring to FIG. 5, the optical device according to the second embodiment of the inventive concept may include a second optical waveguide 22 and a second coupled waveguide 42 disposed on the other side of the laser 30 facing the first optical waveguide 20 and the first coupled waveguide 40,. The first coupled waveguide 40 and the second coupled waveguide 42 may have second Bragg diffraction gratings 80. The second Bragg diffraction grating 80 may include pin holes or polymer. The laser 30 may generate a laser light having a wavelength corresponding to the period of the second Bragg diffraction gratings 80. As compared to the first embodiment, the second embodiment further includes the second optical waveguide 22, the second coupled waveguide 42, and the second Bragg diffraction gratings 80.

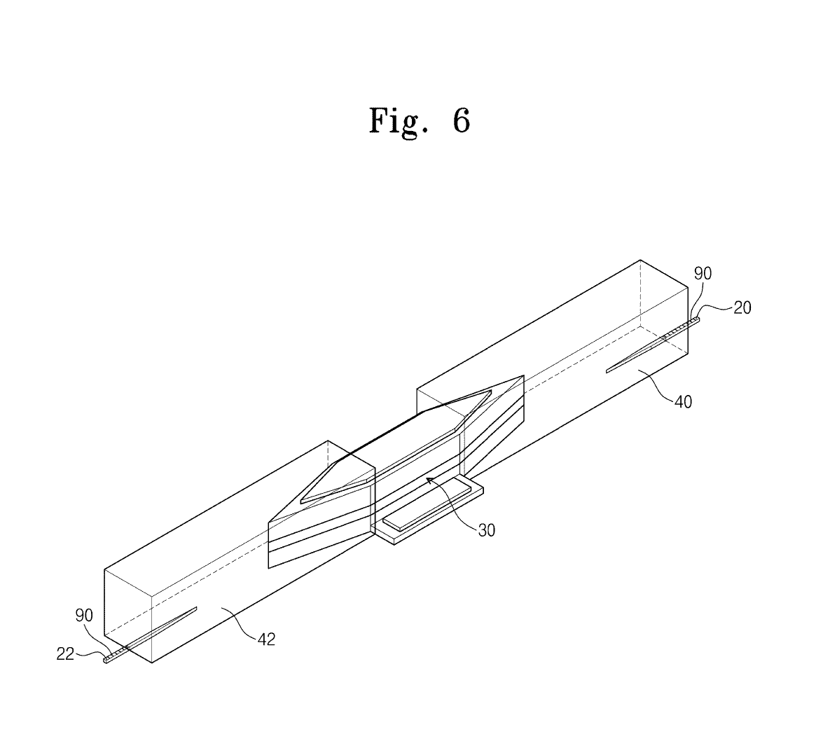

FIG. 6 is a perspective view of an optical device according to a third embodiment of the inventive concept.

Referring to FIG. 6, the optical device according to the third embodiment of the inventive concept may include third Bragg diffraction gratings 90 that are formed on the first optical waveguide 20 and the second optical waveguide 22. The third Bragg diffraction gratings 90 may be formed on the first optical waveguide 20 and the second optical waveguide 22 that are outside the first coupled waveguide 40 and the second coupled waveguide 42.

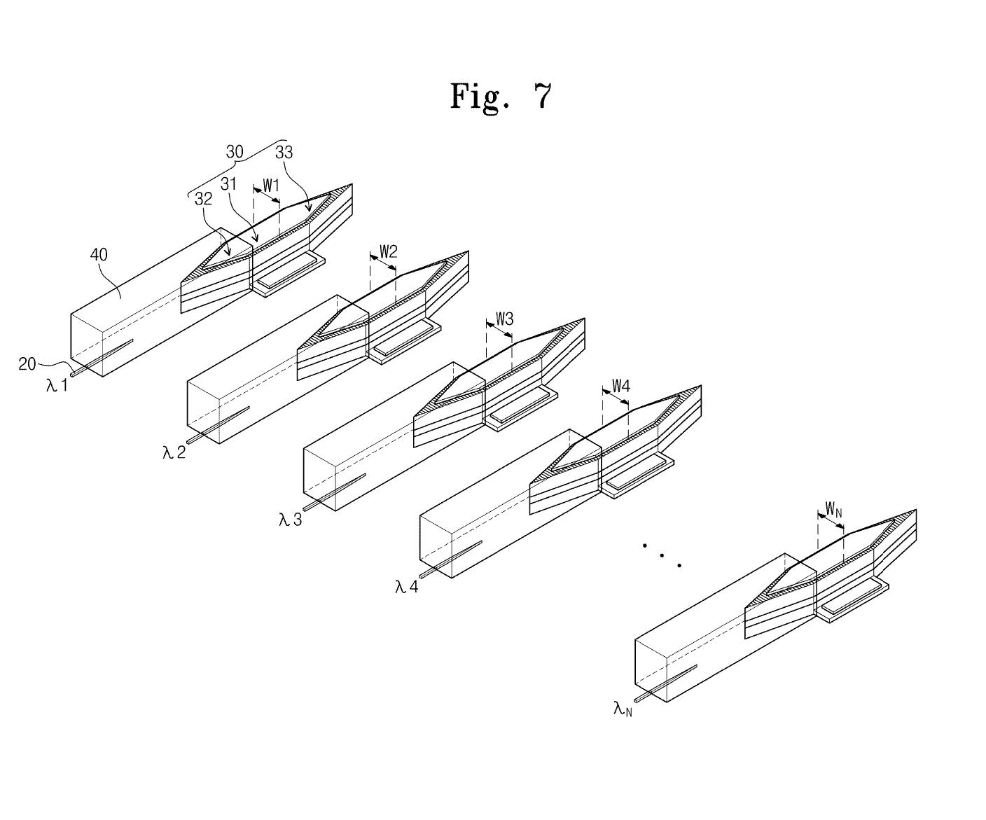

FIG. 7 is a perspective view of an optical device array according to a first application of the present invention.

Referring to FIG. 7, lasers 30 of the optical device according to the first embodiment may be disposed in array. The array type lasers 30 may generate laser lights having first to Nth wavelengths 1 to N that correspond to the line widths W₁ to W_{N} of the laser center waveguide 312. For example, the wavelength of the laser light may increase in proportion to the line width of the laser center waveguide 31 when the period of the first Bragg diffraction grating of each laser is constant.

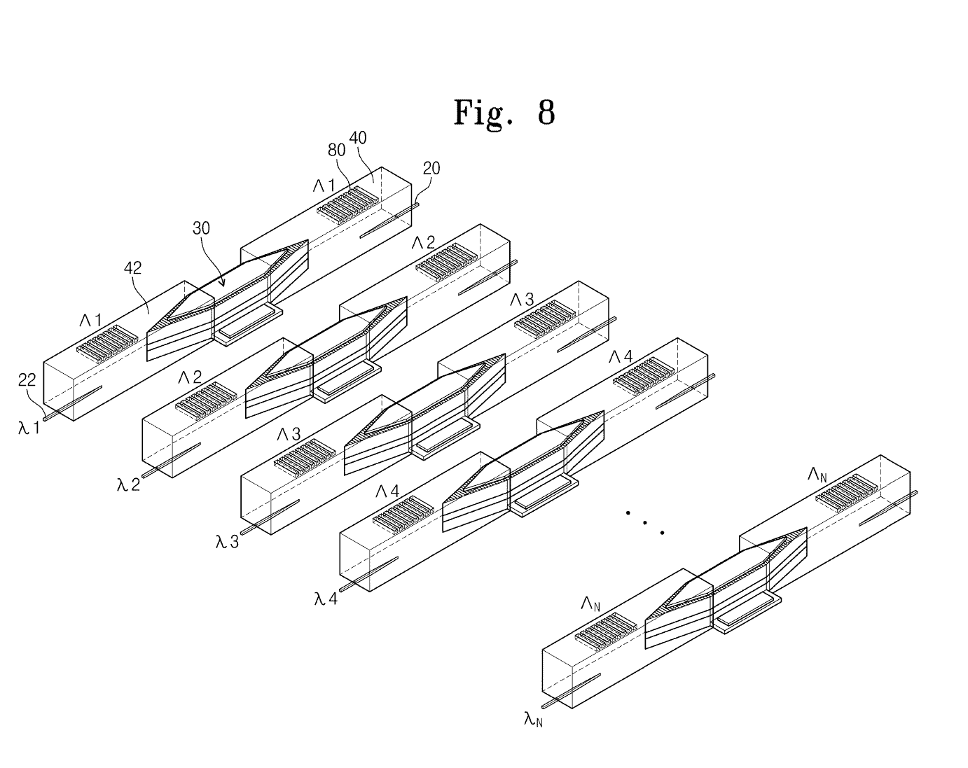

FIG. 8 is a perspective view of an optical device array according to a second application of the present invention. Referring to FIG. 8, the lasers 30 of the optical device according to the second embodiment may generate laser lights having first to Nth wavelengths λ₁ to λ_{N} that correspond to first to Nth periods λ₁ to λ_{N} of the second Bragg diffraction gratings 80. The wavelength of the laser light may increase in proportion to the period or interval of the second Bragg diffraction gratings 80.

A method of manufacturing an optical device according to such first to third embodiments and first and second applications of the present invention is as follows.

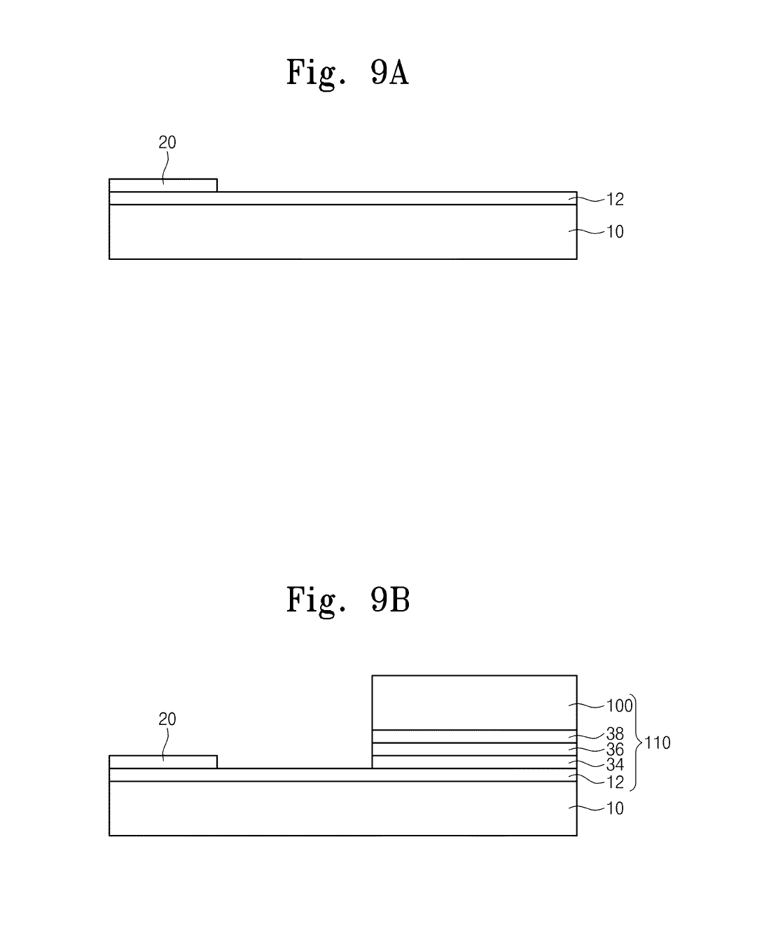

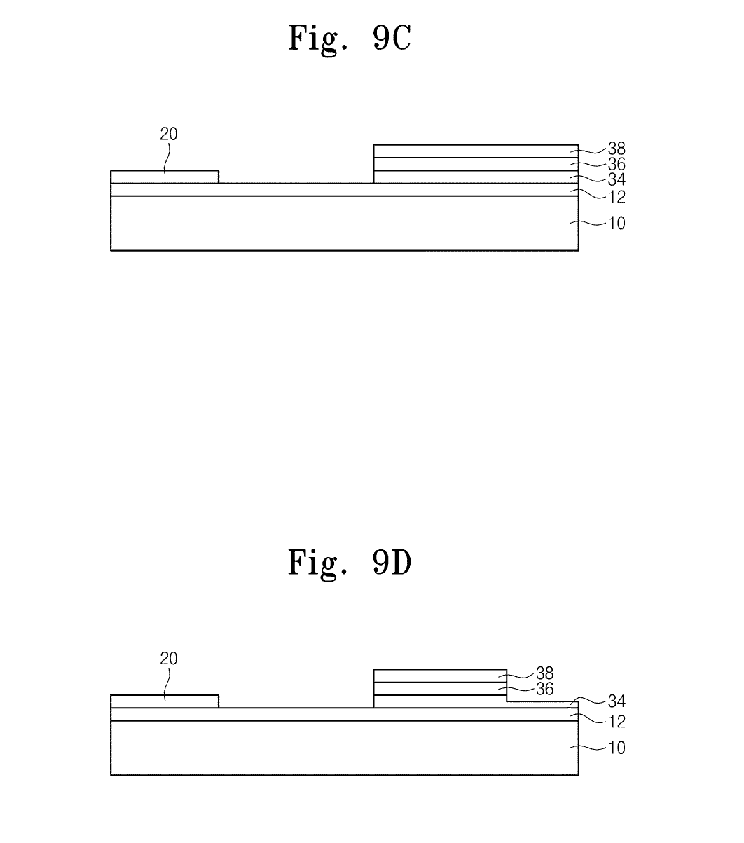

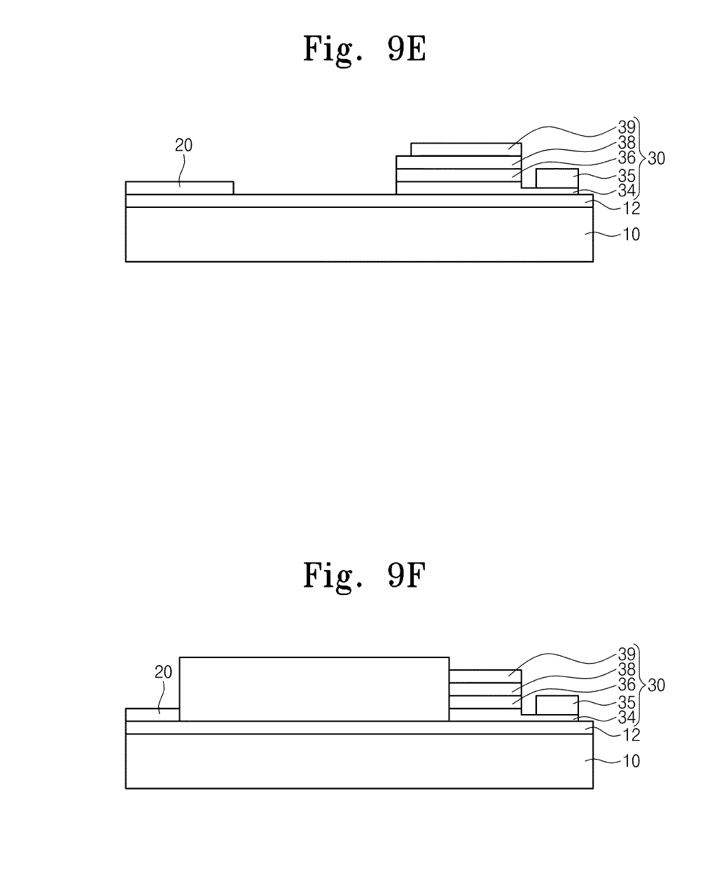

FIGS. 9A to 9F are sequential sectional views of a method of manufacturing an optical device of the present invention.

Referring to FIG. 9A, the buffer layer 12 is formed on the first substrate 10 and the first optical waveguide 20 is disposed on one side of the buffer layer 12.

Referring to FIG. 9B, a wafer 110 is bonded on the other side of the buffer layer 12. A bonding method of the wafer 110 is method that the III-V semiconductor of a different type from the first substrate 10 is bonded on the first substrate 10. The first substrate 10 may include crystalline silicon. The wafer 110 may include the lower clad layer 34, the active layer 36, the upper clad layer 38, and the second substrate 100. The lower clad layer 34, the active layer 36, and the upper clad layer 38 may include the III-V semiconductor. The second substrate 100 may include a III-V semiconductor including InP or GaAs. The present invention is not limited thereto but may make various variations. Unlike this, the second substrate 100 may include crystalline silicon of an intrinsic semiconductor. The lower clad layer 34 may be bonded on the buffer layer 12 by using various wafer bonding techniques. The bonding process of the wafer 110 may enable higher optical coupling efficiency than a typical flip chip technology.

Referring to FIG. 9C, the second substrate 100 is removed. The second substrate 100 may be removed by using a wet etching. The lower clad layer 34, the active layer 36, and the upper clad layer 38 may remain on the buffer layer 12.

Referring to FIGS. 1 and 9D, the upper clad layer 38, the active layer 36, and the lower clad layer 34 are patterned. The upper clad layer 38, the active layer 36, and the lower clad layer 34 may be patterned in a ship shape by using a photolithography process and an etching process.

Referring to FIG. 9E, a first electrode 35 and a second electrode 39 are formed on the lower clad layer 34 and the upper clad layer 38, respectively. The first electrode 35 and the second electrode 39 may be formed by using a metal deposition process, a photolithography process, and an etching process. The first electrode 35 and the second electrode 39 may be formed by using a printing technique. The laser 30 may be monolithically manufactured on the other side of the first substrate 10.

Referring to FIG. 9F, the first coupled waveguide 40 is formed between the first optical waveguide 20 and the laser 30. The first coupled waveguide 40 may cover the upper clad layer 38, the active layer 36, the lower clad layer 34 and the second electrode 39 of the laser 30. The first coupled waveguide 40 may include a silicon oxide nitride film that is disposed by using chemical vapor deposition. The first coupled waveguide 40 may maximize the optical transmission efficiency of the first optical waveguide 20 and the laser 30 without a micro alignment process. Thus, the method of manufacturing the optical device of the present invention may enhance productivity.

As described above, the optical device according to embodiments of the inventive concept includes a first optical waveguide, a first coupled waveguide, and a laser. The first optical waveguide and the laser may be separated apart in the coupled waveguide and tapered toward them. The optical loss of the tapered first optical waveguide and the tapered laser may be minimized The first optical waveguide and the laser are aligned without a long-time micro alignment process. Also, it is possible to monolithically form a laser having a direct bandgap of a III-V semiconductor on a silicon substrate through a wafer bonding process. The wafer bonding process may implement higher optical coupling efficiency than a typical flip chip technology.

Thus, the optical device and the manufacturing method thereof according to embodiments of the inventive concept may enhance productivity.

While embodiments of the inventive concept are described with reference to the accompanying drawings, those skilled in the art will be able to understand that the present invention may be practiced as other particular forms without changing essential characteristics. Therefore, embodiments described above should be understood as illustrative and not limitative in every aspect.

What is claimed is:

1. An optical device comprising:
a first optical waveguide on one side of a substrate;
a laser separated from the first optical waveguide and disposed on the other side of the substrate; and
a first coupled waveguide between the laser and the first optical waveguide,
wherein the laser is monolithically integrated on the substrate.

2. The optical device of claim 1, wherein the laser has a ship shape.

3. The optical device of claim 2, wherein the ship-shaped laser comprises:
a laser center waveguide having any line width; and
a first laser edge waveguide and a second laser edge waveguide connected respectively to both sides of the laser center waveguide and tapered from the laser center waveguide.

4. The optical device of claim 3, wherein the laser generates a laser light having a length proportional to a line width of the laser center waveguide.

5. The optical device of claim 3, wherein the first optical waveguide is tapered toward the laser.

6. The optical device of claim 1, wherein the laser comprises a distributed feedback (DFB) laser.

7. The optical device of claim 6, wherein the laser comprises:
a lower clad layer;
an active layer on the lower clad layer; and
an upper clad layer on the active layer,
wherein the lower clad layer, the active layer and the upper clad layer comprise a III-V semiconductor.

8. The optical device of claim 7, wherein the laser further comprises:
a first electrode on the lower clad layer; and
a second electrode on the upper clad layer.

9. The optical device of claim 8, wherein the first coupled waveguide covers the lower clad layer, the active layer, the upper clad layer, and the second electrode.

10. The optical device of claim 7, wherein the laser further comprises first Bragg diffraction gratings disposed any one of the lower clad layer and the upper clad layer.

11. The optical device of claim 1, further comprising:
a second optical waveguide disposed on the other side of the laser facing the first optical waveguide; and
a second coupled waveguide between the second optical waveguide and the laser.

12. The optical device of claim 11, further comprising second Bragg diffraction gratings disposed on at least any one of the first coupled waveguide and the second coupled waveguide.

13. The optical device of claim 12, wherein the laser generates a laser light having a wavelength proportional to a period of the second Bragg diffraction gratings.

14. The optical device of claim 11, further comprising third Bragg diffraction gratings disposed on at least any one of the first optical waveguide and the second optical waveguide.

15. The optical device of claim 1, further comprising a buffer layer between the laser and the substrate or between the optical waveguide and the substrate.

16. A method of manufacturing an optical device, the method comprising:
forming an optical waveguide on one side of a first substrate;
forming a laser on the other side of the first substrate, the laser spaced apart from the optical waveguide; and
forming a coupled waveguide on the first substrate between the laser and the optical waveguide,
wherein the laser is monolithically formed by using a wafer bonding technique.

17. The method of claim 16, wherein the wafer comprises:
a second substrate;
an upper clad layer on the second substrate;
an active layer on the upper clad layer; and
a lower clad layer on the active layer,
wherein the lower clad layer is bonded to the other side of the first substrate.

18. The method of claim 17, wherein the forming of the laser comprises pattering the upper clad layer, the active layer, and the lower clad layer in a ship shape.

19. The method of claim 17, further comprising forming a buffer layer on the first substrate under the lower clad layer.
